(19) United States
(12) Patent Application Publication
(10) Pub. No.: US 2021/0207776 A1
(43) Pub. Date: Jul. 8, 2021

(54) CONTAINER VALVE

(71) Applicant: NERIKI VALVE CO., LTD., Hyogo (JP)

(72) Inventors: Atsushi ICHITSUBO, Hyogo (JP); Masaru TAKEDA, Hyogo (JP); Shinji OKADA, Hyogo (JP); Koji MIYAZAKI, Hyogo (JP)

(21) Appl. No.: 17/212,649

(22) Filed: Mar. 25, 2021

Related U.S. Application Data
(63) Continuation of application No. PCT/JP2019/037646, filed on Sep. 25, 2019.

(30) Foreign Application Priority Data
Sep. 29, 2018 (JP) 2018-186184

(51) Int. Cl. F17C 13/04; F16K 27/02; F16K 1/02; F16K 31/50; F16K 41/12

(52) U.S. Cl. CPC F17C 13/04; F16K 27/02; F16K 41/12; F16K 31/50; F16K 1/02

(57) ABSTRACT

The flow path of a container valve communicates from a container attachment portion, to be attached to a fluid storage container, to an outlet, and is provided with a valve chamber, accommodating an open/close valve, in a middle part thereof. A portion of the flow path from an end of the container attachment portion to a bottom surface of the valve chamber is set as a primary flow path, and a portion of the flow path from an inner side surface of the valve chamber to an end of the outlet is set as a secondary flow path. In an outer circumferential portion of the bottom surface of the valve chamber, a discharge promotion groove is formed continuously with a portion corresponding to the lateral opening in a circumferential direction. A bottom surface of the secondary flow path is located below a bottom surface of the discharge promotion groove.

### CROSS-REFERENCE TO RELATED APPLICATION

The present application is a continuation application of International Application No. PCT/JP2019/037646, filed Sep. 25, 2019, which claims priority to Japanese Patent Application No. 2018-186184 filed Sep. 29, 2018. The contents of these applications are incorporated herein by reference in their entirety.

### TECHNICAL FIELD

The present invention relates to a container valve that is attachable to, for example, a fluid storage container such as a gas cylinder or the like to regulate discharge of a fluid such as a gas or the like that has filled the fluid storage container.

### BACKGROUND ART

Conventionally, a container valve is often used that is attachable to a fluid storage container (hereinafter, may be referred to simply as a “container”) such as a gas cylinder or the like to regulate entrance and exit of a fluid such as a gas, a liquid or the like by opening or closing an open/close valve (see Patent Document 1).

The container valve described in Patent Document 1, which has a diaphragm structure, is usable as an open/close valve of a high-pressure container and may regulate entrance and exit of a gas, for example, exit of a gas that has filled the container or filling of the container with a gas.

Such a container valve is required to discharge a gas that has filled the container through an outlet provided as an exit opening for the gas at a desired flow rate (pressure) stably in a production process or the like of, for example, semiconductor devices or solar cells.

Recently, along with the improvement of the function and the quality of solar cells, semiconductor devices or the like, it has been more required to discharge the gas at a desired flow rate (pressure) stably through the outlet.

### CITATION LIST

### Patent Literature

Patent Document 1: Japanese Laid-Open Patent Publication No. 2006-144950

### SUMMARY OF INVENTION

### Technical Problem

The present invention made in light of the above-described problem has an object of providing a container valve capable of discharging a fluid that has filled a fluid storage container at a desired flow rate stably.

### Solution to Problem

The present invention is directed to a container valve including a valve main body; a container attachment portion, to be attached to a fluid storage container, provided below the valve main body; an outlet protruding from the valve main body in a direction crossing an up-down direction; a flow path communicating from the container attachment portion to the outlet and having both of two ends thereof opened; a valve chamber provided in a middle part of the flow path; and an open/close valve movable upward and downward in the valve chamber to realize open/close switching. A portion of the flow path from an end of the container attachment portion to a bottom surface of the valve chamber may be set as a primary flow path, and a portion of the flow path from an inner side surface of the valve chamber to a protruding end of the outlet may be set as a secondary flow path. At a circumferential edge of a primary flow path valve chamber-side opening formed in the bottom surface of the valve chamber, a valve seal seat surface portion is formed on which the open/close valve is set when being moved downward so as to close the primary flow path valve chamber-side opening. In an outer circumferential portion of the bottom surface of the valve chamber that is outer to the valve seal seat surface portion, a discharge promotion groove, promoting discharge of a fluid from the valve chamber toward a secondary flow path valve chamber-side opening formed in the inner side surface of the valve chamber, communicates with the secondary flow path valve chamber-side opening and is formed continuously in a circumferential direction. A bottom surface of the secondary flow path is located below a bottom surface of the discharge promotion groove.

According to this invention, the flow path resistance caused when the fluid flows into the secondary flow path from the valve chamber (intra-valve chamber space) may be decreased. Therefore, the fluid that has filled the fluid storage container may be discharged from the outlet at a desired flow rate stably.

Specifically, the fluid may undesirably be retained on, for example, the outer circumferential portion of the bottom surface of the valve chamber or the like in the case where the fluid is of a certain type or the container valve is used in a certain manner.

However, as described above, the discharge promotion groove is formed in the outer circumferential portion of the bottom surface of the valve chamber, and also the bottom surface of the secondary flow path is located below the bottom surface of the discharge promotion groove. Therefore, the fluid is not retained in a bottom part of the secondary flow path valve chamber-side opening formed in the inner side surface of the valve chamber. Thus, the fluid may be discharged to the secondary flow path, and also the fluid may be drained toward the secondary flow path.

Therefore, the fluid that has filled the fluid storage container may be discharged from the outlet smoothly and stably without being retained in the intra-valve chamber space.

In an embodiment of the present invention, the valve seal seat surface portion may be formed to be flat.

According to this invention, when the open/close valve is moved downward, a bottom surface thereof contacts the valve seal seat surface portion firmly in a planar contact state. Therefore, the open/close valve may provide firm sealability on the primary flow path valve chamber-side opening.

In an embodiment of the present invention, the discharge promotion groove may be formed to incline so as to become gradually deeper in a diametrically outward direction of the outer circumferential portion of the bottom surface of the valve chamber.

According to this invention, the discharge promotion groove, inclining so as to become deeper toward an outer portion in the diametrically outward direction, may promote the flow of the fluid that has flown into the valve chamber from the primary flow path valve chamber-side opening, such that the fluid flows toward the secondary flow path valve chamber-side opening formed in the inner side surface of the valve chamber, namely, in the diametrically outward direction. This may result in promoting the discharge of the fluid toward the secondary flow path via the secondary flow path valve chamber-side opening.

In an embodiment of the present invention, the discharge promotion groove may include a corner portion, between the bottom surface thereof and the inner side surface of the valve chamber, having an arcked cross-section taken along a plane extending in the up-down direction.

According to this invention, the discharge promotion groove having the arcked cross-section may decrease the frictional resistance of the fluid flowing in the corner portion between the bottom surface of the discharge promotion groove and the inner side surface of the valve chamber, and thus may allow the fluid to flow smoothly in the circumferential direction along the arcked corner portion. This may result in promoting the discharge of the fluid toward the secondary flow path from the secondary flow path valve chamber-side opening formed in the inner side surface of the valve chamber.

Since the corner portion between the bottom surface of the discharge promotion groove and the inner side surface of the valve chamber is formed so as to have the arcked cross-section taken along a plane extending in the up-down direction, the fluid may be suppressed from being retained in the corner portion.

With the above-described structure, the fluid that has filled the fluid storage container may be discharged from the outlet at a desired flow rate more stably.

In an embodiment of the present invention, the discharge promotion groove may be formed to incline so as to become gradually deeper toward a position corresponding to the second flow path valve chamber-side opening, in a circumferential direction of the outer circumferential surface portion of the bottom surface of the valve chamber.

According to this invention, the discharge promotion groove inclining in the circumferential direction promotes the flow of the fluid that has flown into the valve chamber from the primary flow path valve chamber-side opening, such that the fluid flows toward the secondary flow path valve chamber-side opening, in the circumferential direction of the outer circumferential portion of the bottom surface of the valve chamber.

### Advantageous Effects of Invention

According to the present invention, a fluid that has filled a fluid storage container may be discharged at a desired flow rate stably.

### BRIEF DESCRIPTION OF DRAWINGS

FIG. 1 is a schematic cross-sectional view of a container valve according to an embodiment of the present invention.

FIG. 2A is an enlarged view of region X1 in FIG. 1, and FIG. 2B is an enlarged view of region X2 in FIG. 2A.

FIG. 3 is a cross-sectional view taken along line A-A in FIG. 2A.

FIG. 4 is an enlarged view of a main part of a container valve in another embodiment of the present invention and corresponds to FIG. 3.

FIGS. 5A to 5B provide cross-sectional views taken along lines B-B, C-C and D-D, and a developed cross-sectional view taken along a plane extending in an up-down direction represented by phantom line L.

FIG. 6 is a schematic cross-sectional view of a conventional container valve and corresponds to FIG. 1.

### DESCRIPTION OF EMBODIMENTS

Hereinafter, embodiments of the present invention will be described in detail with reference to the drawings.

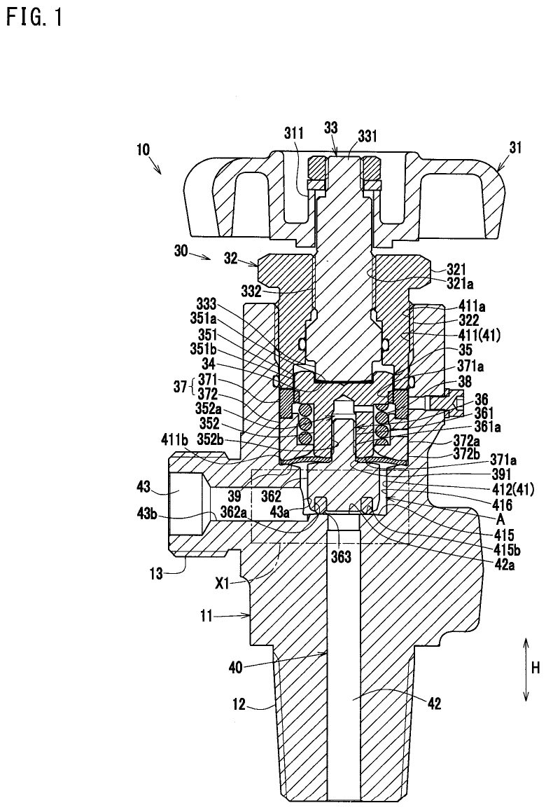

In the following description and the drawings, an O ring or the like is provided at a position where elements of a shut-off valve mechanism 30 face each other or at an appropriate position where the shut-off valve mechanism 30 and the valve body 11 face each other. A detailed description of such an O ring or the like will be omitted where not necessary. In FIG. 1, the direction of “H” represents an up-down direction (height direction) of a container valve 10. A cylinder container (not shown) to which the container valve 10 is to be attached is to be filled with a corrosive liquefied gas fluid.

Before describing a structure of a main part of the container valve 10 in this embodiment, a basic structure of the container valve 10 will be described mainly with reference to FIG. 1.

FIG. 1 is a schematic cross-sectional view of the container valve 10 in this embodiment, taken along a plane extending in the up-down direction, more specifically, along a plane that is perpendicular to a circumferential direction of the container valve 10 and divides an outlet 13 into two.

The container valve 10 is of a diaphragm system, and is to be attached to a cylinder container (not shown) to regulate entrance of a corrosive liquefied gas fluid into the cylinder container in order to supply the corrosive liquefied gas fluid to the cylinder container or fill the cylinder container with the corrosive liquefied gas fluid.

The container valve 10 includes a valve body 11, a cylinder attachment portion 12, the outlet 13, and the shut-off valve mechanism 30.

In the container valve 10, the valve body 11, which is of a generally cylindrical shape longer in the up-down direction H, and the cylinder attachment portion 12, which is provided below the valve body 11, are integrally formed with each other. The cylinder attachment portion 12 is to be screwed to, and thus attached to, a top attachment portion of the cylinder container.

Also in the container value 10, the outlet 13 is provided in a middle part of the valve body 11 in the up-down direction so as to protrude in a direction perpendicular to the up-down direction H, namely, protrude laterally. The shut-off valve mechanism 30 is attached to a top part inside the valve body 11.

The valve body 11 accommodates a valve chamber 41 allowing the shut-off valve mechanism 30 to be attached to a top part thereof, a primary flow path 42 communicating from a bottom end of the valve chamber 41 to a bottom end of the cylinder attachment portion 12, and a secondary flow path 43 communicating from the bottom end of the valve chamber 41 to a tip end of the outlet 13 in a direction perpendicular to the valve chamber 41.

The valve chamber 41 includes an operation chamber 411, which is a generally cylindrical recessed portion that is opened upward, and a shut-off valve chamber 412 provided below the operation chamber 411 and having a diameter shorter than that of the operation chamber 411.

In the valve body 11, the shut-off valve chamber 412, the primary flow path 42 and the secondary flow path 43 form a flow path 40, which communicates from the bottom end of the cylinder attachment portion 12 to the protruding tip end of the outlet 13.

The primary flow path 42 communicates from a bottom surface 415 of the shut-off valve chamber 412 to the bottom end of the cylinder attachment portion 12, and is opened at both of two ends thereof. The primary flow path 42 is formed as an up-down-direction hole extending downward (toward the bottom end of the cylinder attachment portion 12) linearly from a central part of the bottom surface 415 of the shut-off valve chamber 412.

The secondary flow path 43 communicates from an inner side surface 416 of the shut-off valve chamber 412 to the tip end of the outlet 13 and is opened at both of two ends thereof. The secondary flow path 43 is formed as a lateral hole extending laterally (toward the tip end of the outlet 13) linearly and horizontally from a position, of the inner side surface 416, corresponding to the outlet 13 in a circumferential direction thereof.

A valve seat surface 415b is formed at a position that is the central part of the bottom surface 415 of the shut-off valve chamber 412 as seen in a plan view and is a circumferential edge of a top end opening 42a of the primary flow path 42 (the top end opening 42a is a primary flow path valve chamber-side opening). On the valve seat surface 415b, a bottom surface of an open/close valve main body 362 (open/close valve) is set when the open/close valve main body 362 is moved downward.

The valve seat surface 415b is formed to be flat and horizontal, and is formed to be of a circle having a diameter generally equal to that of the bottom surface of the open/close valve main body 362 as seen in a plan view. When the open/close valve main body 362 is moved downward, a seat ring 363 (described below) of the open/close valve main body 362 is put into close contact with the valve seat surface 415b and closes the top end opening 42a.

The shut-off valve mechanism 30 attached to the valve chamber 41 includes a rotatable handle 31, a gland nut 32, a spindle 33, a thrust washer 34, a retainer 35, an open/close valve 36, a stop sleeve 37 including a stop ring 371 and a sleeve 372, a spring 38, and a diaphragm 39.

The rotatable handle 31 is formed to be generally circular cloud-shaped as seen in a plan view and has a wavy outer circumferential edge with eight protrusions. The rotatable handle 31 includes an engaging portion 311 allowing an engageable portion 331 in a top part of the spindle 33 to be engaged therewith.

The gland nut 32 is a generally cylindrical hollow member including a head nut 321 and a male thread 322. The male thread 322 is screwable with a female thread 411a formed at an inner surface of the operation chamber 411 of the valve chamber 41. A female thread 321a screwable with a male thread 332 of the spindle 33 is formed at an inner surface of the gland nut 32.

The spindle 33 has a generally cylindrical shape longer in the up-down direction and includes the engageable portion 331, the male thread 332, and a pressing bottom portion 333 provided in this order from top to bottom.

Regarding the spindle 33, the engageable portion 331 is engaged with the engaging portion 311 of the rotatable handle 31, and the male thread 332 is screwed with the female thread 321a formed at the inner surface of the gland nut 32 described above. In addition, a bottom surface of the pressing bottom portion 333 of the spindle 33 is rotated while sliding against the retainer 35 described below and presses the retainer 35.

The thrust washer 34 is a plate-like member that is circular as seen in a plan view, and is located between the pressing bottom portion 333 of the spindle 33 and the retainer 35.

The retainer 35 includes a retainer head 351 and a cylindrical portion 352 integrally formed with each other. The retainer head 351 is circular as seen in a plan view, and has a male thread 351b formed at an outer surface thereof. The cylindrical portion 352 is provided below the retainer head 351, is opened downward, and has a diameter shorter than that of the retainer head 351. The cylindrical portion 352 includes a cylindrical hollow portion 352a having a female thread 352b formed at an inner surface thereof.

The retainer head 351 includes a recessed portion 351a recessed in a cross-sectional view. The recessed portion 351a allows the pressing bottom portion 333 of the spindle 33 to be engaged therewith.

The open/close valve 36 provided as a shut-off member includes a top protrusion 361 and the open/close valve main body 362 integrally formed with each other. The top protrusion 361 is insertable into the cylindrical hollow portion 352a of the cylindrical portion 352 of the retainer 35, and includes a male thread 361a screwable with the female thread 352b. The open/close valve main body 362 has a diameter longer than that of the cylindrical portion 352 of the retainer 35.

The bottom surface of the open/close valve main body 362 is formed to be flat and has a size sufficiently large to close the top end opening 42a of the primary flow path 42. A circular groove 362a is formed at an outer circumferential surface of the bottom surface of the open/close valve main body 362. The circular groove 362a is concentric with the bottom surface and has a diameter longer than that of the top end opening 42a. The seat ring 363 is engaged with the circular groove 362a at the bottom surface of the open/close valve main body 362.

When being moved upward, the open/close valve main body 362 is separated from the valve seat surface 415b. When the open/close valve main body 362 is moved downward, the seat ring 363 contacts the valve seat surface 415b and closes the top end opening 42a. Namely, the open/close valve main body 362 is separated from, or contacts, the valve seat surface 415b to open or close the top end opening 42a.

An intra-valve chamber space A is formed between the open/close valve main body 362 formed to be cylindrical and the inner side surface 416 of the shut-off valve chamber 412 of the valve chamber 41, which is a cylindrical space.

The stop ring 371 forming the stop sleeve 37 together with the sleeve 372 has a generally cylindrical shape, and supports the gland nut 32 from below such that the gland nut 32 is relatively rotatable and also presses the sleeve 372 (described below) from above. In addition, the stop ring 371 has a female thread 371a at a top inner surface thereof. The female thread 371a allows the male thread 351b formed at the outer surface of the retainer head 351 of the retainer 35 to be screwed therewith.

The sleeve 372 includes a cylindrical main body 372a and a reduced diameter portion 372b. A top surface of the cylindrical main body 372a is pressed downward by a bottom end of the stop ring 371. The reduced diameter portion 372b carries a bottom portion of the spring 38 (described below), and holds a circumferential edge of the diaphragm 39 (described below) together with a bottom surface 411b of the operation chamber 411.

The cylindrical main body 372a is outserted over the cylindrical portion 352 of the retainer 35.

In an assembled state, the spring 38 is outserted over the cylindrical portion 352 of the retainer 35, and is also held in the up-down direction between a bottom surface of the retainer head 351 and a top surface of the reduced diameter portion 372b of the sleeve 372. The spring 38 uses the reduced diameter portion 372b of the sleeve 372 as a reaction force to urge the retainer 35 upward.

The diaphragm 39 is a thin circular plate including a central circular opening 391 allowing the top protrusion 361 of the open/close valve 36 to be inserted thereinto. The diaphragm 39 is located on the bottom surface 411b of the operation chamber 411 so as to cover a top part of the shut-off valve chamber 412. The diaphragm 39 may include a plurality of stacked thin metal plates, and a coating layer may be formed on one of surfaces, facing each other, of the thin metal plates.

As described above, the shut-off valve mechanism 30 includes the rotatable handle 31, the gland nut 32, spindle 33, the thrust washer 34, the retainer 35, the open/close valve 36, the stop sleeve 37 (stop ring 371 and the sleeve 372), the spring 38, and the diaphragm 39. The male thread 322 of the gland nut 32 and the female thread 411a of the valve chamber 41 are screwed with each other, so that the shut-off valve mechanism 30 is inserted into the valve chamber 41.

In the container valve 10 including the shut-off valve mechanism 30 inserted into the valve chamber 41 as described above, when the rotatable handle 31 is rotated in a direction of being loosened to protrude the spindle 33, the open/close valve 36 is released from a pressed state via the retainer 35 and the diaphragm 39.

The open/close valve 36, when being released from the pressed state, moves upward by an urging force of the spring 38. As a result, the top opening 42a is opened, and the flow path 40 including the primary flow path 42 and the secondary flow path 43 communicating with each other via the shut-off valve chamber 412 is put into a communication state. In other words, the primary flow path 42 and the secondary flow path 43 communicate with each other via the shut-off valve chamber 412; namely, a valve-open state is realized.

By contrast, when the rotatable handle 31 is rotated in a direction of being tightened to retract the spindle 33, the open/close valve 36 is pressed downward via the retainer 35 and the diaphragm 39 against the urging force of the spring 38. As a result, the top opening 42a of the primary flow path 42, that has been opened toward the shut-off valve chamber 412, is closed by the open/close valve 36, and the primary flow path 42 and the secondary flow path 43 forming the flow path 40 are separated from each other. In other words, the intra-valve chamber space A formed in the shut-off valve chamber 412 and the primary flow path 42 are separated from each other; namely, a valve-closed state is realized.

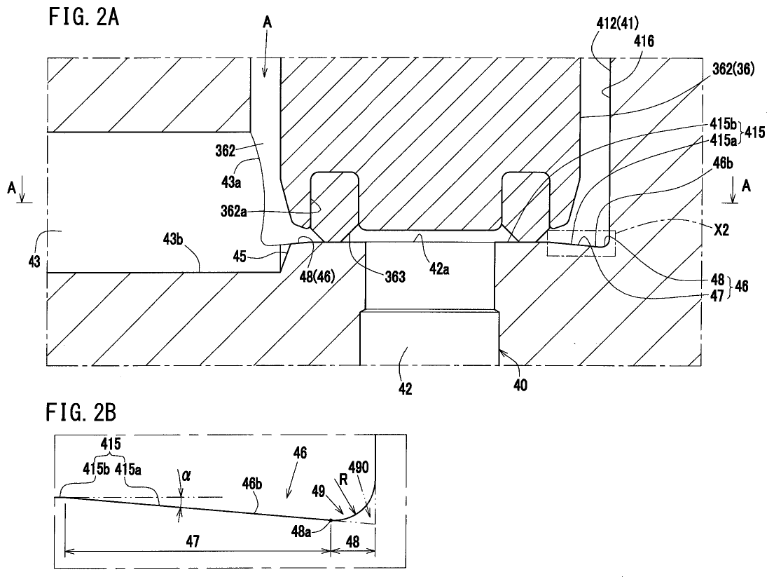

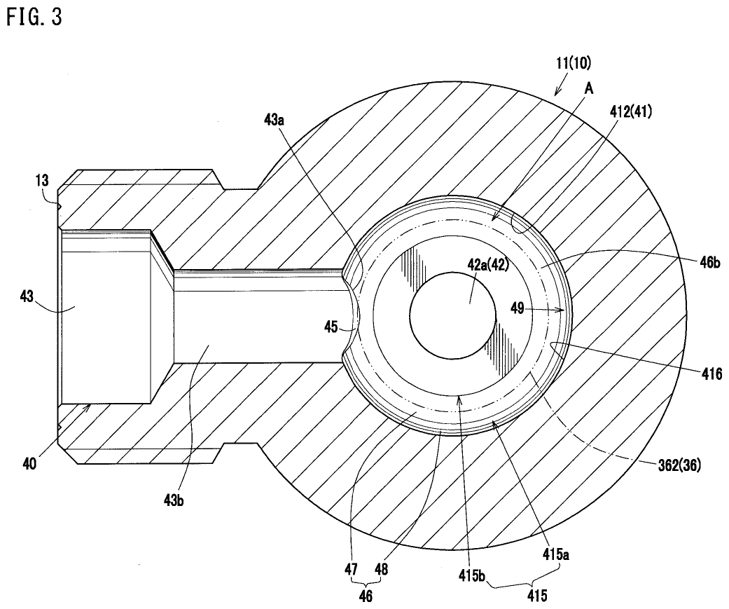

Now, the structure of the main part of the container valve 10 in this embodiment will be described mainly with reference to FIG. 2A, FIG. 2B and FIG. 3.

FIG. 2A is an enlarged view of region X1 in FIG. 1, FIG. 2B is an enlarged view of region X2 in FIG. 2A, and FIG. 3 is a cross-sectional view taken along line A-A in FIG. 2A.

As shown in FIG. 2A and FIG. 3, a discharge promotion groove 46 is formed in generally the entirety of an outer circumferential portion 415a in a circumferential direction thereof. The outer circumferential portion 415a is a portion of the bottom surface 415 of the shut-off valve chamber 412 that is outer to the valve seat surface 415b (hereinafter, the outer circumferential portion 415a will be referred to as the “bottom surface outer circumferential portion 415a”) (see FIG. 3).

The discharge promotion groove 46 promotes discharge of the corrosive liquefied gas fluid contained in the intra-valve chamber space A of the shut-off valve chamber 412 to the secondary flow path 43 from a lateral opening 43a formed at the inner side surface 416 of the shut-off valve chamber 412.

In other words, as shown in the above-mentioned figures, the valve seat surface 415b is formed to be higher (at a higher position) than the bottom surface outer circumferential portion 415a so as to be enclosed by the bottom surface outer circumferential portion 415a as seen in a plan view (see FIG. 2A and FIG. 2B). Therefore, the valve seat surface 415b higher than the bottom surface outer circumferential portion 415a corresponds to a top surface of the central part, as seen in a plan view, of the bottom surface 415. The central part rises like a pedestal.

As shown in FIG. 2A, FIG. 2B and FIG. 3, the discharge promotion groove 46 includes an inclining discharge promotion groove 47 and an arcked discharge promotion groove 48. The inclining discharge promotion groove 47 is formed of apart of, or the entirety of, the bottom surface outer circumferential portion 415a. The arcked discharge promotion groove 48 is located diametrically outer to the inclining discharge promotion groove 47.

As shown especially in FIG. 2B, the inclining discharge promotion groove 47 is formed such that a cross-section thereof taken along a plane extending in the up-down direction (i.e., the cross-section taken along a plane extending in the up-down direction and in the diametrical direction) inclines linearly so as to become gradually deeper from an outer edge of the valve seat surface 415b toward the inner side surface 416 in a diametrical direction of the valve seat surface 415b. The inclining discharge promotion groove 47 in this example is formed to have an inclination angle α of about 10 degrees with respect to the valve seat surface 415b, which is horizontal.

As shown in the above-mentioned figure, the arcked discharge promotion groove 48 is formed as follows. A portion between the outer circumferential portion 415a of the bottom surface 415 of the shut-off valve chamber 412, namely, the inclining discharge promotion groove 47, and the inner side surface 416 is labeled as a corner portion 49. The arcked discharge promotion groove 48 is formed such that a cross-section of the corner portion 49 taken along a plane extending in the up-down direction and in the diametrical direction is arcked. The arcked cross-section of the arcked discharge promotion groove 48 in this example has a radius R of curvature of about 0.5 mm (see the above-mentioned figure).

The arcked discharge promotion groove 48 is formed such that a tangent of a diametrical-direction inner end 48a thereof (i.e., the end 48a adjacent to the inclining discharge promotion groove 47) (see FIG. 2A) inclines at the same or generally the same angle as the inclination angle of the inclining discharge promotion groove 47. With such a structure, the inclining discharge promotion groove 47 and the arcked discharge promotion groove 48 form a smooth inclining surface that is continuous in the diametrical direction.

As shown in FIG. 2A, a bottom surface 43b of the secondary flow path 43 is located below the bottom surface 415 of the shut-off valve chamber 412 described above.

Specifically, as described above, the secondary flow path 43 is formed as a lateral hole extending laterally from a part, in the circumferential direction, of the inner side surface 416 of the shut-off valve chamber 412. The lateral opening 43a, of the secondary flow path 43, formed to be opened toward the intra-valve chamber space A in the shut-off valve chamber 412 includes an inclining portion 45 at a bottom edge thereof. The inclining portion 45 inclines obliquely downward such that the bottom surface 43b of the secondary flow path 43 is lower than the bottom surface 415 of the shut-off valve chamber 412.

The bottom surface 43b of the secondary flow path 43 is located, by the inclining portion 45, below the bottom surface 415 of the shut-off valve chamber 412 (described above), especially, below a bottom surface 46b of the discharge promotion groove 46. In this example, as shown in FIG. 2A, the inclining portion 45 includes an up-down-direction stepped portion by which the bottom surface 43b of the secondary flow path 43 is located below the diametrical-direction inner end 48a (see FIG. 2B) of the arcked discharge promotion groove 48. The diametrical-direction inner end 48a is located at the deepest position of the bottom surface 415 of the shut-off valve chamber 412.

In other words, as shown in FIG. 2A, an end, on the side of the lateral opening 43a, of the bottom surface 43b of the secondary flow path 43 and an end, on the side of the lateral opening 43a, of the bottom surface 46b of the discharge promotion groove 46 are connected with each other via the inclining portion 45. Namely, a region from the valve seat surface 415b to the bottom surface 43b of the secondary flow path 43, including the bottom edge of the lateral opening 43a and the like, is formed to become gradually deeper without any stepped portion or the like higher than, for example, the bottom surface 415 of the shut-off valve chamber 412. Such a structure becoming gradually deeper is realized by the discharge promotion groove 46 and the inclining portion 45.

In this example, as shown in FIG. 2A and FIG. 3, the discharge promotion groove 46 (in this example, the arcked discharge promotion groove 48) is formed to have a cut-off portion at a position corresponding to the lateral opening 43a in the circumferential direction of the bottom surface 415 of the shut-off valve chamber 412. The bottom surface 43b of the secondary flow path 43 is formed to protrude diametrically internally onto the bottom surface 415 of the shut-off valve chamber 412 until reaching a position corresponding to the arcked discharge promotion groove 48.

As described above, the bottom surface 43b of the secondary flow path 43 is formed to protrude diametrically internally onto the bottom surface 415, so that a front part (on the side of the intra-valve chamber space A) of a bottom portion of the lateral opening 43a is opened.

With such a structure, the bottom portion of the lateral opening 43a is not closed by the bottom surface 415 of the shut-off valve chamber 412. Thus, the area size of the opening of the lateral opening 43a is prevented from being substantially narrowed even by the structure in which the bottom surface 43b of the secondary flow path 43 is located below the bottom surface 415 of the shut-off valve chamber 412 by the inclining portion 45.

As shown in FIG. 3, the bottom surface 43b of the secondary flow path 43 is formed to protrude even to a part, in the circumferential direction, of the arcked discharge promotion groove 48, which is formed along generally the entirety of the circumference of the bottom surface 415 of the shut-off valve chamber 412. Namely, the lateral opening 43a has a shape that allows the liquefied gas fluid retained in the shut-off valve chamber 412 to easily flow toward the secondary flow path 43 along the arcked discharge promotion groove 48.

As shown in FIG. 1, FIG. 2A, FIG. 2B and FIG. 3, the above-described container valve 10 in this embodiment includes the valve body 11, the cylinder attachment portion 12, the outlet 13, the flow path 40, the shut-off valve chamber 412, and the open/close valve 36.

The container valve 10 includes the cylinder attachment portion 12 below the valve body 11 provided as a valve main body. The cylinder attachment portion 12 is provided as a container attachment portion and is attached to the cylinder container (not shown) provided as a fluid storage container. The container valve 10 includes the outlet 13 protruding in a direction perpendicular to the up-down direction (in a diametrically outward direction) from the valve body 11. The flow path 40 opened at both of the two ends thereof communicates the cylinder attachment portion 12 and the outlet 13 to each other.

The shut-off valve chamber 412 provided as a valve chamber is provided in a middle part of the flow path 40 of the container valve 10. The open/close valve 36 movable upward and downward to realize open/close switching is provided in the shut-off valve chamber 412 (in the intra-valve chamber space A).

In the flow path 40 of the container valve 10, a portion from the end of the cylinder attachment portion 12 to the bottom surface 415 of the shut-off valve chamber 412 is set as the primary flow path 42, and a portion from the inner side surface 416 of the shut-off valve chamber 412 to the protruding end of the outlet 13 is set as the secondary flow path 43.

The valve seat surface 415b is formed at the circumferential edge of the top opening 42a (first flow path valve chamber-side opening) formed in the bottom surface 415 of the shut-off valve chamber 412. On the valve seat surface 415b, the open/close valve 36 is set when being moved downward so as to close the top opening 42a.

In addition, the discharge promotion groove 46 is formed in the bottom surface outer circumferential portion 415a, which is a portion, of the bottom surface 415 of the shut-off valve chamber 412, that is diametrically outer to the valve seat surface 415b. The discharge promotion groove 46 is formed continuously with a portion corresponding to the lateral opening 43a in the circumferential direction (see FIG. 3).

The discharge promotion groove 46 promotes discharge of the corrosive liquefied gas fluid, provided as a fluid, from the intra-valve chamber space A in the shut-off valve chamber 412 to the lateral opening 43a (secondary flow path valve chamber-side opening) formed in the inner side surface 416 of the shut-off valve chamber 412.

In addition, the bottom surface 43b of the secondary flow path 43 (see FIG. 2A) is located below the bottom surface 46b of the discharge promotion groove 46 (see FIG. 2B) (see FIG. 2A and FIG. 2B).

As described above, in the container valve 10 in this embodiment, the bottom surface 43b of the secondary flow path 43 is located below the bottom surface 46b of the discharge promotion groove 46.

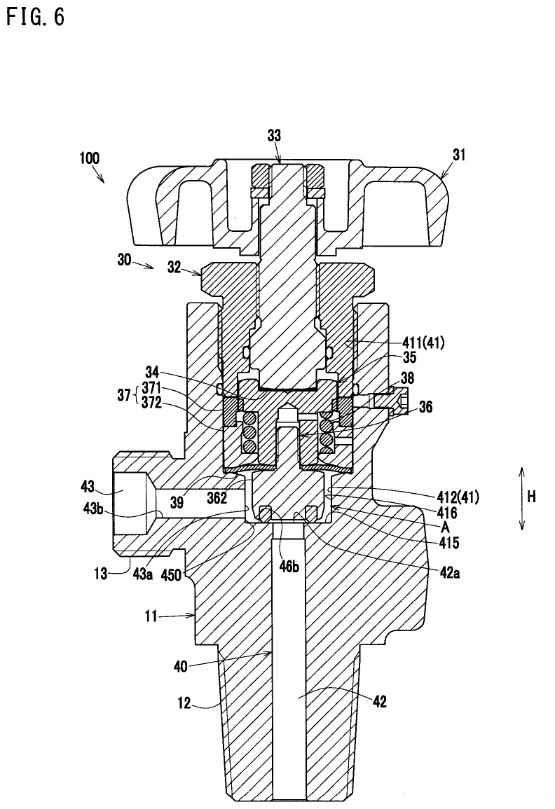

Namely, in the container valve 10 in this embodiment, the bottom surface 43b of the secondary flow path 43 is not located above the bottom surface 46b of the discharge promotion groove 46 unlike, for example, in a container valve 100 shown in FIG. 6.

In the container valve 10 in this embodiment, for example, the bottom portion of the lateral opening 43a accommodates no stepped portion 450 or the like rising from the bottom surface 415 of the shut-off valve chamber 412, more specifically, from the bottom surface 46b of the discharge promotion groove 46.

Therefore, the container valve 10 in this embodiment may decrease the flow path resistance caused when the corrosive liquefied gas fluid flows into the secondary flow path 43 from the intra-valve chamber space A in the shut-off valve chamber 412.

FIG. 6 is a schematic cross-sectional view of the conventional container valve 100 taken along a plane extending in the up-down direction, and corresponds to FIG. 1.

Especially in the case where the fluid is the corrosive liquefied gas fluid, for example, the corrosive liquefied gas fluid may occasionally be retained in the intra-valve chamber space A in the shut-off valve chamber 412 via the secondary flow path 43 when the container valve 10 is used in a certain manner. Specifically, the corrosive liquefied gas fluid may undesirably be retained on, for example, the bottom surface outer circumferential portion 415a of the shut-off valve chamber 412 or the like.

However, in this embodiment, as described above, the discharge promotion groove 46 is formed in the bottom surface outer circumferential portion 415a of the shut-off valve chamber 412 (see FIG. 2A, FIG. 2B and FIG. 3), and also the bottom surface 43b of the secondary flow path 43 is located below the bottom surface 46b of the discharge promotion groove 46 (see FIG. 2A and FIG. 2B). With such a structure, the bottom portion of the lateral opening 43a formed in the inner side surface 416 of the shut-off valve chamber 412 acts as the flow path resistance and thus prevents the corrosive liquefied gas fluid from being retained. Therefore, the corrosive liquefied gas fluid, which is to flow to the second flow path 43, may be drained to the second flow path 43.

As described above, the flow path resistance caused when the fluid flows into the secondary flow path 43 from the intra-valve chamber space A is decreased. This may increase the flow rate of the corrosive liquefied gas fluid to be drained. This may also result in improving the effect of discharging the corrosive liquefied gas fluid retained in the shut-off valve chamber 412 toward the secondary flow path 43.

Therefore, even when the corrosive liquefied gas fluid is retained in the intra-valve chamber space A, the corrosive liquefied gas fluid that has filled the fluid storage container may be discharged from the outlet 13 smoothly and stably.

There are cases where the container valve 10 is washed when getting dirty after being used.

The discharge promotion groove 46 is provided in the shut-off valve chamber 412. Therefore, when the container valve 10 is to be washed, the discharge of a solvent (washing detergent) or the like, used to wash the inside of the container valve 10, from the intra-valve chamber space A to the lateral opening 43a is promoted, like the discharge of the corrosive liquefied gas fluid described above. Thus, the washing detergent may be drained from the inside of the container valve 10 easily.

The valve seat surface 415b is formed to be flat (see FIG. 1, FIG. 2A and FIG. 3). With such a structure, when the open/close valve 36 is moved downward, the seat ring 363 provided at a bottom surface thereof is set on the valve seat surface 415b with no gap. As can be seen, the bottom surface of the open/close valve 36 is set firmly. Therefore, the open/close valve 36 may provide firm sealability on the top opening 42a.

The discharge promotion groove 46 includes the inclining discharge promotion groove 47. The inclining discharge promotion groove 47 inclines so as to become gradually deeper from an outer circumferential edge of the valve seat surface 415b toward the inner side surface 416 of the shut-off valve chamber 412 in the diametrical direction of the bottom surface outer circumferential portion 415a of the shut-off valve chamber 412 (see FIG. 2A, FIG. 2B and FIG. 3). The inclining discharge promotion groove 47 having such a structure may promote the flow of a fluid such as the corrosive liquefied gas fluid or the like, that has flown into the intra-valve chamber space A from the top opening 42a, toward the lateral opening 43a formed in the inner side surface 416 of the shut-off valve chamber 412, namely, diametrically outward. This may result in promoting the discharge of the fluid to the secondary flow path 43 via the lateral opening 43a.

The discharge promotion groove 46 includes the arcked discharge promotion groove 48. The arcked discharge promotion groove 48 is the corner portion 49 between the inclining discharge promotion groove 47 and the inner side surface 416 of the bottom surface 415 of the shut-off valve chamber 412, and has an arcked cross-section taken along a plane extending in the up-down direction (see FIG. 2A and FIG. 2B). The arcked discharge promotion groove 48 having such a structure may decrease the frictional resistance of the fluid flowing in the corner portion 49 between the bottom surface 415 of the shut-off valve chamber 412 and the inner side surface 416, and thus may allow the fluid to flow smoothly in the circumferential direction along the corner portion 49 having an arcked cross-section. This may result in promoting the discharge of the fluid to the secondary flow path 43 from the lateral opening 43a formed in the inner side surface 416 of the shut-off valve chamber 412.

Especially, even in the case where it is possible that the corrosive liquefied gas fluid is undesirably retained in the shut-off valve chamber 412, the arcked discharge promotion groove 48 having an arcked cross-section taken along a plane extending in the up-down direction may suppress the corrosive liquefied gas fluid from being retained as described above.

Namely, the container valve 10 in this embodiment may suppress the corrosive liquefied gas fluid from being retained in the corner portion 49, unlike a container valve including a non-rounded corner portion 490 represented with a phantom line in FIG. 2B.

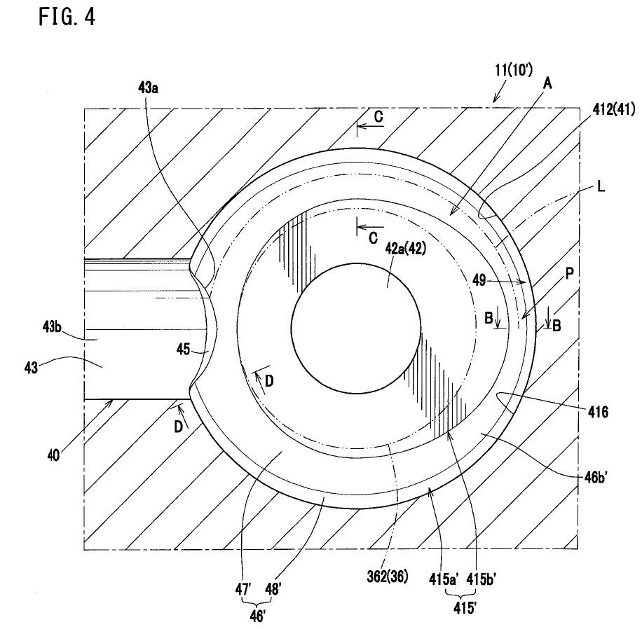

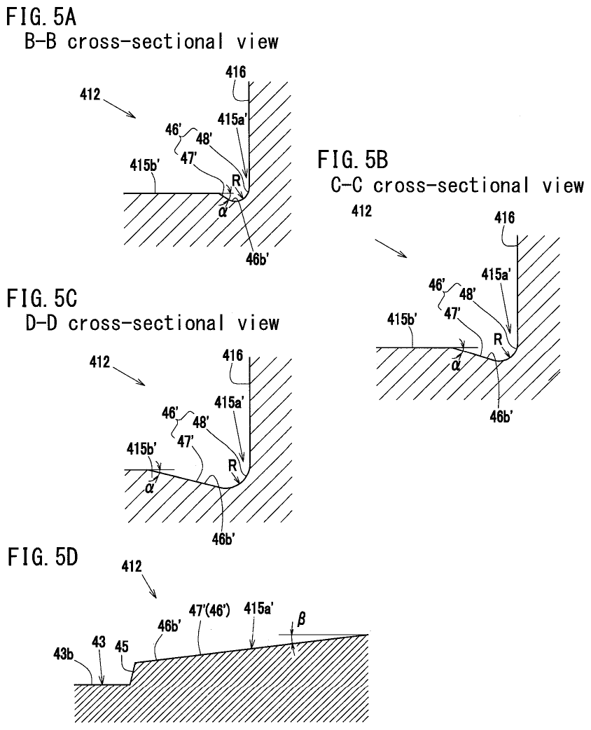

Now, with reference to FIG. 4, FIG. 5A, FIG. 5B, FIG. 5C and FIG. 5D, a modification of the container valve 10 in the above-described embodiment will be described.

It should be noted that the same elements as those in the above-described embodiment will bear the same reference signs and descriptions thereof will be omitted. FIG. 4 is an enlarged view of a main part of a container valve 10′ in another embodiment and corresponds to FIG. 3. FIG. 5A is a cross-sectional view taken along line B-B in FIG. 4, FIG. 5B is a cross-sectional view taken along line C-C in FIG. 4, FIG. 5C is a cross-sectional view taken along line D-D in FIG. 4, and FIG. 5D is a developed cross-sectional view taken along a plane extending in the up-down direction as represented by phantom line L in FIG. 4.

A discharge promotion groove 46′ is formed in a bottom surface outer circumferential portion 415a′ of the shut-off valve chamber 412 in a circumferential direction thereof, so as to become gradually deeper and wider toward the lateral opening 43a.

Specifically, as shown in FIG. 4 and FIG. 5A, an inclining discharge promotion groove 47′ is formed to be narrower than the inclining discharge promotion groove 47 in the above-described embodiment at a position P on the circumference of the bottom surface outer circumferential portion 415a′ (see FIG. 4), at which the inclining discharge promotion groove 47′ is farthest from the lateral opening 43a.

Namely, the inclining discharge promotion groove 47′ is formed to be narrower than the inclining discharge promotion groove 47 in the above-described embodiment at the position P on the bottom surface outer circumferential portion 415a′ of the shut-off valve chamber 412. The position P faces the lateral opening 43a with the top opening 42a being held therebetween as seen in a plan view.

As shown in FIG. 4, FIG. 5A, FIG. 5B and FIG. 5C, the inclining discharge promotion groove 47′ is formed to become gradually wider in the circumferential direction of the bottom surface outer circumferential portion 415a′, toward the lateral opening 43a from the position P farthest from the lateral opening 43a.

As shown in FIG. 5A, FIG. 5B and FIG. 5C, the inclining discharge promotion groove 47′ is formed to have an inclining surface at a bottom surface 46b′ in the entirety of the circumferential direction of the bottom surface outer circumferential portion 415a′ of the shut-off valve chamber 412, like the inclining discharge promotion groove 47 described above.

A cross-section of the inclining surface of the bottom surface 46b′ taken along a plane extending in the up-down direction and in the diametrical direction inclines linearly so as to become gradually deeper from the outer edge of a valve seat surface 415b′ toward the inner side surface 416 (in the diametrically outward direction). The bottom surface 46b′ has an inclination angle α that is set to be about 10 degrees, which is equal to that of the inclining discharge promotion groove 47.

As described above, the inclination angle α of the inclining discharge promotion groove 47′ is set to be the same in the entirety of the circumferential direction of the bottom surface outer circumferential portion 415a′ of the shut-off valve chamber 412. By contrast, the inclining discharge promotion groove 47′ is formed to become gradually wider toward a position corresponding to the lateral opening 43a, in the circumferential direction of the bottom surface outer circumferential portion 415a′ (see FIG. 4, FIG. 5A, FIG. 5B and FIG. 5C).

As shown in FIG. 5D, the inclining discharge promotion groove 47′ inclines so as to become gradually deeper toward the position corresponding to the lateral opening 43a, in the circumferential direction of the bottom surface outer circumferential portion 415a′ (see, especially, inclination angle β in the circumferential direction of the bottom surface outer circumferential portion 415a′ in FIG. 5D).

As shown in FIG. 5A, FIG. 5B and FIG. 5C, the arcked discharge promotion groove 48′ is set to have a radius R of curvature that is equal to that of the arcked discharge promotion groove 48 described above in the entirety of the circumferential direction of the bottom surface outer circumferential portion 415a′.

As shown in FIG. 4, FIG. 5A, FIG. 5B, FIG. 5C and FIG. 5D, the container valve 10′ in the another embodiment described above includes the discharge promotion groove 46′, which inclines so as to become gradually deeper toward the position corresponding to the lateral opening 43a, in the circumferential direction of the bottom surface outer circumferential portion 415a′. The discharge promotion groove 46′ inclining in the circumferential direction in this manner allows the corrosive liquefied gas fluid, that has flown into the intra-valve chamber space A in the shut-off valve chamber 412 from the top opening 42a, to flow toward the lateral opening 43a in the circumferential direction of the bottom surface outer circumferential portion 415a′ of the shut-off valve chamber 412. Namely, the discharge promotion groove 46′ may promote the discharge of the corrosive liquefied gas fluid toward the lateral opening 43a formed in the inner side surface 416 of the shut-off valve chamber 412.

The present invention is not limited to the structure of the above-described embodiments, but may be carried out in any of various other embodiments.

For example, in the above-described embodiments, the discharge promotion grooves 46 and 46′ are formed in generally the entirety of the circumference of the bottom surface outer circumferential portions 415a and 415a′. The present invention is not limited to having such a structure. It is sufficient that the discharge promotion grooves 46 and 46′ are each continuous with a portion corresponding to the lateral opening 43a in the circumferential direction. Namely, the discharge promotion grooves 46 and 46′ may each be divided in the circumferential direction of the bottom surface outer circumferential portions 415a and 415a′.

The bottom surface 43b of the secondary flow path 43 is located below the bottom surface outer circumferential portions 415a and 415a′ of the shut-off valve chamber 412 described above. The present invention is not limited to having such a structure. It is sufficient that the discharge of the corrosive liquefied gas fluid is promoted from the shut-off valve chamber 412 to the secondary flow path 43 via the lateral opening 43a.

Namely, it is sufficient that the bottom surface 43b of the secondary flow path 43 is structured so as not to inhibit the discharge of the corrosive liquefied gas fluid from the shut-off valve chamber 412 to the secondary flow path 43 via the lateral opening 43a. For example, the present invention does not eliminate a structure in which the bottom surface 43b is formed at the same height as that of the bottom surface 415 of the shut-off valve chamber 412.

The discharge promotion grooves 46 and 46′ are not limited to including the arcked discharge promotion grooves 48 and 48′, each of which is the corner portion 49 having an arcked cross-section taken along a plane extending in the up-down direction and held between the bottom surfaces 415 and 415′ of the shut-off valve chamber 412 and the inner side surface 416. The corner portion 49 may be chamfered.

In the container valve 10′ in the another embodiment described above, the discharge promotion groove 46′ is formed to become gradually deeper and wider toward the lateral opening 43a in the circumferential direction of the bottom surface outer circumferential portion 415a′. The present invention is not limited to having such a structure.

Namely, it is sufficient that the discharge promotion groove 46′ has a structure of promoting the flow of the fluid in the circumferential direction of the bottom surface outer circumferential portion 415a′ of the shut-off valve chamber 412 from the intra-valve chamber space A so as to discharge the corrosive liquefied gas fluid, retained in the shut-off valve chamber 412, from the lateral opening 43a.

For example, the discharge promotion groove 46′ may be formed to have a constant width and a varying depth in the circumferential direction of the bottom surface outer circumferential portion 415a′.

In the above-described another modification regarding the container valve 10′, for varying the depth of the discharge promotion groove 46′ in the circumferential direction of the bottom surface outer circumferential portion 415a′, the width of the discharge promotion groove 46′ (especially, the inclining discharge promotion groove 47′) is varied in the circumferential direction of the bottom surface outer circumferential portion 415a′. The present invention is not limited to this.

Namely, in the container valve 10′, the inclination angle (gradient) of the inclining discharge promotion groove 47′ or the radius of curvature of the arcked discharge promotion groove 48′ may be varied in the circumferential direction of the bottom surface outer circumferential portion 415a′.

In the above description, the corrosive liquefied gas fluid is used. Alternatively, the container valve may be used to store a usual non-corrosive gas or a non-liquefied gas fluid in a cylinder container or to fill a cylinder container with a usual non-corrosive gas or a non-liquefied gas fluid. Still alternatively, the container valve may be used to store a liquid, instead of a gas, in a cylinder container or to fill a cylinder container with a liquid.

In the above description, the container valves 10 and 10′ are of a diaphragm system. The present invention is not limited to this, and is applicable to a packing valve.

### REFERENCE SIGNS LIST

10, 10′ . . . container valve
11 . . . valve body (valve main body)
12 . . . cylinder attachment portion (container attachment portion)
13 . . . outlet
36 . . . open/close valve
40 . . . flow path
42 . . . primary flow path
42a . . . top opening (primary flow path valve chamber-side opening)
43 . . . secondary flow path
43b . . . bottom surface of the secondary flow path
43a . . . lateral opening (secondary flow path valve chamber-side opening)
46, 46′ . . . discharge promotion groove
46b, 46b‘ . . . bottom surface of the discharge promotion groove
47, 47’ . . . inclining discharge promotion groove
48, 48′ . . . arcked discharge promotion groove
412 . . . shut-off valve chamber (valve chamber)
415, 415′ . . . bottom surface of the shut-off valve chamber (bottom surface of the valve chamber)
415a, 415a′ . . . bottom surface outer circumferential portion (outer circumferential portion of the bottom surface of the valve chamber)
415b, 415b′ . . . valve seat surface
416 . . . inner side surface of the valve chamber
A . . . intra-valve chamber space (inside of the valve chamber)

1. A container valve, comprising:
a valve main body;
a container attachment portion, to be attached to a fluid storage container, provided below the valve main body;
an outlet protruding from the valve main body in a direction crossing an up-down direction;
a flow path communicating from the container attachment portion to the outlet and having both of two ends thereof opened;
a valve chamber provided in a middle part of the flow path; and
an open/close valve movable upward and downward in the valve chamber to realize open/close switching,
wherein:
a portion of the flow path from an end of the container attachment portion to a bottom surface of the valve chamber is set as a primary flow path, and a portion of the flow path from an inner side surface of the valve chamber to a protruding end of the outlet is set as a secondary flow path,
at a circumferential edge of a primary flow path valve chamber-side opening formed in the bottom surface of the valve chamber, a valve seal seat surface portion is formed on which the open/close valve is set when being moved downward so as to close the primary flow path valve chamber-side opening,
in an outer circumferential portion of the bottom surface of the valve chamber that is outer to the valve seal seat surface portion, a discharge promotion groove, promoting discharge of a fluid from the valve chamber toward a secondary flow path valve chamber-side opening formed in the inner side surface of the valve chamber, communicates with the secondary flow path valve chamber-side opening and is formed continuously in a circumferential direction, and
a bottom surface of the secondary flow path is located below a bottom surface of the discharge promotion groove.

2. The container valve according to claim 1, wherein the valve seal seat surface portion is formed to be flat.

3. The container valve according to claim 1, wherein the discharge promotion groove is formed to incline so as to become gradually deeper in a diametrically outward direction of the outer circumferential portion of the bottom surface of the valve chamber.

4. The container valve according to claim 2, wherein the discharge promotion groove is formed to incline so as to become gradually deeper in a diametrically outward direction of the outer circumferential portion of the bottom surface of the valve chamber.

5. The container valve according to claim 1, wherein the discharge promotion groove includes a corner portion, between the bottom surface thereof and the inner side surface of the valve chamber, having an arcked cross-section taken along a plane extending in the up-down direction.

6. The container valve according to claim 2, wherein the discharge promotion groove includes a corner portion, between the bottom surface thereof and the inner side surface of the valve chamber, having an arcked cross-section taken along a plane extending in the up-down direction.

7. The container valve according to claim 3, wherein the discharge promotion groove includes a corner portion, between the bottom surface thereof and the inner side surface of the valve chamber, having an arcked cross-section taken along a plane extending in the up-down direction.

8. The container valve according to claim 4, wherein the discharge promotion groove includes a corner portion, between the bottom surface thereof and the inner side surface of the valve chamber, having an arcked cross-section taken along a plane extending in the up-down direction.

9. The container valve according to claim 1, wherein the discharge promotion groove is formed to incline so as to become gradually deeper toward a position corresponding to the second flow path valve chamber-side opening, in a circumferential direction of the outer circumferential surface portion of the bottom surface of the valve chamber.

10. The container valve according to claim 2, wherein the discharge promotion groove is formed to incline so as to become gradually deeper toward a position corresponding to the second flow path valve chamber-side opening, in a circumferential direction of the outer circumferential surface portion of the bottom surface of the valve chamber.

11. The container valve according to claim 3, wherein the discharge promotion groove is formed to incline so as to become gradually deeper toward a position corresponding to the second flow path valve chamber-side opening, in a circumferential direction of the outer circumferential surface portion of the bottom surface of the valve chamber.

12. The container valve according to claim 4, wherein the discharge promotion groove is formed to incline so as to become gradually deeper toward a position corresponding to the second flow path valve chamber-side opening, in a circumferential direction of the outer circumferential surface portion of the bottom surface of the valve chamber.

13. The container valve according to claim 5, wherein the discharge promotion groove is formed to incline so as to become gradually deeper toward a position corresponding to the second flow path valve chamber-side opening, in a circumferential direction of the outer circumferential surface portion of the bottom surface of the valve chamber.

14. The container valve according to claim 6, wherein the discharge promotion groove is formed to incline so as to become gradually deeper toward a position corresponding to the second flow path valve chamber-side opening, in a circumferential direction of the outer circumferential surface portion of the bottom surface of the valve chamber.

15. The container valve according to claim 7, wherein the discharge promotion groove is formed to incline so as to become gradually deeper toward a position corresponding to the second flow path valve chamber-side opening, in a circumferential direction of the outer circumferential surface portion of the bottom surface of the valve chamber.

16. The container valve according to claim 8, wherein the discharge promotion groove is formed to incline so as to become gradually deeper toward a position corresponding to the second flow path valve chamber-side opening, in a circumferential direction of the outer circumferential surface portion of the bottom surface of the valve chamber.
